(19) United States
(12) Patent Application Publication
(10) Pub. No.: US 2004/0087332 A1
(43) Pub. Date: May 6, 2004

(54) Apparatus and method for simultaneous operation of a base transceiver subsystem in a wireless network

(75) Inventors: Robert W. Monroe, Melissa, TX (US); Joseph R. Cleveland, Richardson, TX (US)

Correspondence Address: Docket Clerk, P.O. Drawer 800889, Dallas, TX, 75380, US

(73) Assignee: SAMSUNG ELECTRONICS CO., LTD., Suwon-City (KR)

(21) Appl. No.: 10/284,970

(22) Filed: Oct. 31, 2002

(51) Int. Cl. H04Q 7/20

(52) U.S. Cl. 455/524; 455/101

(57) ABSTRACT

An apparatus for coupling a first base transceiver subsystem (BTS) and a second base transceiver subsystem (BTS) of a wireless network to a first antenna and a second antenna associated with a to cell site of the wireless network. The apparatus comprises: 1) a first interface circuit for coupling a main receive path and a main transmit path of the first BTS to the first antenna; and 2) a second interface circuit for coupling a main receive path and a main transmit path of the second BTS to the second antenna and coupling a diversity receive path of the first BTS to the second antenna.

the new upgraded equipment, and bringing the network back on-line. Another area of enhancing performance is achieved at regularly scheduled maintenance windows. This is typically accomplished during non-peak hours, when there is low traffic. The cell site equipment is taken off-line, the maintenance is performed, and the cell site is brought back on-line. In addition to downtime caused by upgrades and regular maintenance, network failures also occur at the cell site, resulting in further downtime for the cell site equipment.

Any reduction in customer traffic due to the upgrading of equipment, maintenance of the network, or network failure has a tremendous impact on revenues and profits of the wireless service providers. This downtime is directly related to the reduction in service availability, loss of wireless service provider income, and a disruption to current users. Accordingly, these factors tend to render the maintenance, upgrade, or failure of prior art base transceiver subsystems difficult, expensive, and undesirable.

There is, therefore, a need in the art for providing a system for minimizing down time of a base transceiver subsystem in a wireless network. In particular, there is a need for a system that seamlessly performs maintenance and upgrades, and that provides for failure of a base transceiver subsystem with minimal downtime, thereby minimizing the impact to current subscribers and maximizing the use of cell site equipment including antenna towers, antenna arrays, and the like.

### SUMMARY OF THE INVENTION

It is an object of the present invention to overcome the above-discussed deficiencies of the prior art, and more specifically, it is a primary object of the present invention to provide an interface that permits simultaneous operation of two base transceiver subsystems via a shared pair of antennas in a wireless network.

The present invention provides an apparatus for coupling a first base transceiver subsystem (BTS) and a second base transceiver subsystem (BTS) of a wireless network to a first antenna and a second antenna associated with a cell site of the wireless network. According to an advantageous embodiment of the present invention, the apparatus comprises: 1) a first interface circuit capable of coupling a main receive path and a main transmit path of the first BTS to the first antenna; and 2) a second interface circuit capable of coupling a main receive path and a main transmit path of the second BTS to the second antenna and coupling a diversity receive path of the first BTS to the second antenna.

According to one embodiment of the present invention, the first interface circuit is further capable of coupling a diversity receive path of the second BTS to the first antenna.

According to another embodiment of the present invention, the first interface circuit simultaneously couples the main receive and transmit paths of the first BTS to the first antenna and the diversity receive path of the second BTS to the first antenna.

According to still another embodiment of the present invention, the first interface circuit comprises switching circuitry that alternately couples the main receive and transmit paths of the first BTS to the first antenna and the diversity receive path of the second BTS to the first antenna.

According to yet another embodiment of the present invention, the second interface circuit simultaneously couples the main receive and transmit paths of the second BTS to the second antenna and the diversity receive path of the first BTS to the second antenna.

According to a further embodiment of the present invention, the second interface circuit comprises switching circuitry that alternately couples the main receive and transmit paths of the second BTS to the second antenna and the diversity receive path of the first BTS to the second antenna.

These and other advantages and features of the present invention will become readily apparent to those skilled in the art upon examination of the subsequent detailed description and accompanying drawings. Accordingly, additional advantages and features of the present invention and the scope thereof are pointed out with particularity in the claims and form a part hereof.

### BRIEF DESCRIPTION OF THE DRAWINGS

A more complete understanding of the present invention, its preferred embodiments, further objects, and advantages thereof, will become more apparent by reference to the following detailed description taken in conjunction with the accompanying drawings, wherein like reference numbers indicate like elements, and in which:

FIG. 1 depicts a general overview of an exemplary wireless network according to one embodiment of the present invention;

FIG. 2 illustrates an exemplary base station in accordance with a first embodiment of the present invention;

FIG. 3 illustrates an exemplary base station in accordance with a second embodiment of the present invention;

FIG. 4 illustrates an exemplary base station in accordance with a third embodiment of the present invention;

FIG. 5 illustrates an exemplary base station in accordance with a fourth embodiment of the present invention; and

FIG. 6 illustrates an exemplary base station in accordance with a fifth embodiment of the present invention.

### DETAILED DESCRIPTION OF THE INVENTION

Reference will now be made to the following detailed description of the exemplary embodiments of the present invention. Those skilled in the art will recognize that the present invention provides many inventive concepts and novel features that are merely illustrative and are not to be construed as restrictive. Accordingly, the specific embodiments discussed herein are given by way of example and should not be construed to limit the scope of the present invention.

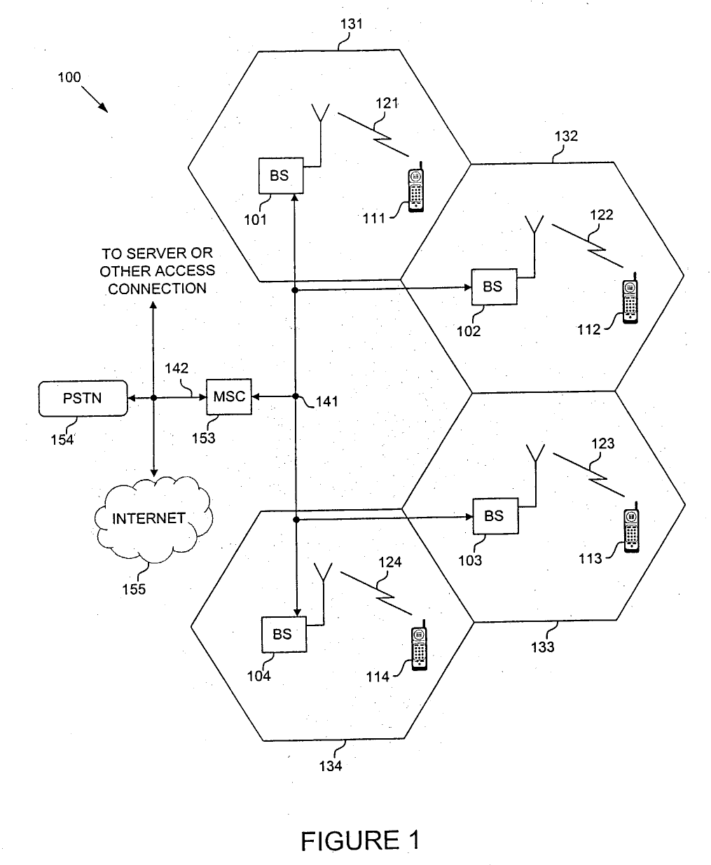

FIG. 1 illustrates a general overview of an exemplary wireless network 100 according to one embodiment of the present invention. Wireless network 100 comprises a plurality of geographically dispersed cell sites 131-134 in which base stations, such as BS 101, BS 102, BS 103, and BS 104 are located. Base stations 101-104 are operable to communicate with a plurality of mobile stations (MS) 111-114. Radio frequency (RF) communication links 121-124 provide the operable connection between the base stations 101-104 and the mobile stations (MS) 111-114. Mobile stations (MS) 111-114 may be any suitable cellular device, for example, conventional cellular telephones, portal handset devices, personal digital assistant devices, portable computers, metering devices, or the like.

Cells sites 121-123 are shown as idealized interlocking hexagons in which base stations 101-104 are located. It should be noted that, in a typical wireless network, actual cell sites are irregularly shaped and overlap in non-uniform configurations, depending on the features of the terrain, such as natural obstructions, man-made obstructions, zoning restrictions, and the like. Cell sites are often subject to other uncontrollable influences.

For simplicity and clarity, only a single base station and a single mobile station are shown and described in each respective cell site, as is unique to the present invention or necessary for an understanding of the present invention. In reality, however, one or more of cell sites 131-134, may be comprised of multiple base stations, each of which communicates with a plurality of mobile stations.

In one advantageous embodiment of the present invention, base stations 101-104 may comprise a base station controller (BSC) and one or more base transceiver subsystems (BTSs). Base station controllers and base transceiver subsystems are well known to those skilled in the art. A base station controller manages the wireless communications resources, including the base transceiver subsystems, for specified cells within a wireless communications network. A base transceiver subsystem comprises the RF transceivers, antennas, and other circuitry and electrical equipment located in each respective cell site.

In a preferred embodiment of the present invention, the antenna array of base station (BS) 101 is a multi-sector antenna, such as a three-sector antenna, in which each antenna sector is responsible for transmitting and receiving in a 120° arc of coverage area. Additionally each multi-sector antenna may employ well known diversity reception techniques, wherein a main antenna and a diversity antenna are co-located on an antenna tower.

As is well known to those skilled in the art, diversity reception is a method by which a receiver receiving multiple signals carrying the same information combines the signals to provide an improved estimate of a transmitted signal. The multiple signals propagate along different delay paths to the receiver. A diversity receiver architecture uses two independent receive paths, known as the main receive path and the diversity receive path, to detect the multiple transmitted signals. Diversity techniques utilize multiple antenna arrays for a cell site and may comprise at least two antennas, wherein a first antenna is coupled to the main receive path and a second antenna is coupled to the diversity receive path.

As indicated in FIG. 1, the base station is located within the center of each respective cell site 131-134. Accordingly, in a typical wireless network, multiple base transceiver subsystems may be connected to a single base station controller within a respective cell site and a plurality of base station controllers may be connected to a single mobile switching center, such as mobile switching center (MSC) 153. However, for simplicity and clarity in explaining the operation of the present invention, only a single base station is shown and described within its respective cell site, accordingly represented by BS 101, BS 102, BS 103 and BS 104.

In the exemplary wireless network 100, MS 111 is located in cell site 131 and is in operable communication with BS 101, MS 112 is located in cell site 132 and is in operable communication with BS 102, MS 113 is located in cell site 133 and is in operable communication with BS 103, and MS 114 is located in cell site 134 and is in operable communication with BS 104. BS 101, BS 102, BS 103, and BS 104 are in operable communication with each other and mobile switching center (MSC) 153 via communications line 141. Mobile switching center (MSC) 153 is well known to those skilled in the art. Mobile switching center (MSC) 153 provides services and coordination between the subscribers in a wireless network and external networks, such as the public switched telephone network (PSTN) 154, Internet 155, and a server or other communication access connections, via communications line 142.

According to an advantageous embodiment of the present invention, base station (BS) 101 comprises at least two base transceiver subsystems, which are operably coupled to a multi-sector antenna array employing diversity reception. This coupling is accomplished by means of a novel interface controller in accordance with the principles of the present invention. The new interface controller is placed in the transmit and receive path of the base station (BS) 101. The present invention allows for the interchangeability of the base transceiver subsystems without compromise to system usability. The present invention enables a wireless service provider to perform maintenance and upgrades seamlessly, and minimizes down time in the event of a failure of a base transceiver subsystem.

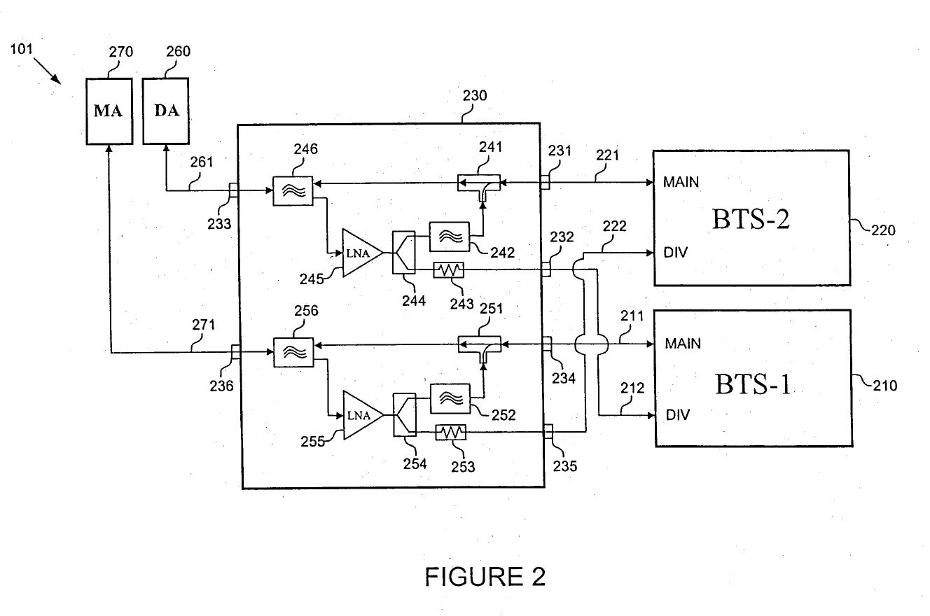

FIG. 2 illustrates an exemplary base station 101 in accordance with a first embodiment of the present invention. Base station 101 comprises a first base transceiver subsystem 210, which may be referred to hereafter as “BTS-1”, a second base transceiver subsystem 220, which may be referred to hereafter as “BTS-2”, an interface controller 230, a diversity antenna (DA) 260, and a main antenna (MA) 270. Interface controller 230 comprises a plurality of input/output (I/O) ports 231-236 and two interface circuits. A first interface circuit comprises directional coupler 241, filter 242, attenuator 243, RF splitter 244, low noise amplifier (LNA) 245, and duplexer 246. A second interface circuit comprises directional coupler 251, filter 252, attenuator 253, RF splitter 254, low noise amplifier (LNA) 255, and duplexer 256.

Main antenna 270 transmits RF downlink signals to mobile stations in its respective coverage area from base transceiver subsystem 210 via interface controller 230. The main transmit signal path 211 is transmitted from BTS-1, through I/O port 234, into interface controller 230, through directional coupler 251 into filter 256. The filtered signal is further transmitted out of the interface controller 230, through I/O port 236, to the main antenna 270, via signal path 271.

The main antenna 270 is a bi-directional link that also receives RF uplink signals from mobile stations in its respective coverage area through interface controller 230, and transmits the RF uplink signals to the main receiver of base transceiver subsystem 210 and to the diversity receiver of base transceiver subsystem 220. The RF uplink signals are propagated through main antenna 270, along signal path 271, into I/O port 236 of interface controller 230, and through filter 256 into low noise amplifier 255. The amplified RF uplink signal from LNA 255 is split into two amplified signals by RF splitter 254. A first amplified signal is coupled to one input of directional coupler 251, by filter 252. Filter 252 protects the output of LNA 255, by reflecting unwanted RF downlink signals from directional coupler 251 back towards BTS-1. Directional coupler 251 sends the filtered first amplified signal out of interface controller 230 via I/O port 234, and into the main receive path of BTS-1 via signal path 211. A second amplified signal is attenuated by attenuator 253 and transmitted out of interface controller 230 via I/O port 235, and into the diversity receive path of BTS-2 via signal path 222.

The diversity antenna (DA) 260 transmits RF downlink signals to mobile stations in its respective coverage area from the second base transceiver subsystem 220 (i.e., BTS-2) via interface controller 230. The main transmit signal path 221 carries RF downlink signals from BTS-2 into I/O port 231 of interface controller 230, and through directional coupler 241 into filter 246. The filtered signal is further transmitted out of interface controller 230 via I/O port 233, and to the diversity antenna 260, via signal path 261.

The diversity antenna 260 is a bi-directional link that also receives RF uplink signals from mobile stations in its respective coverage area through interface controller 230, and transmits the RF uplink signals to the main receiver of base transceiver subsystem 220 and to the diversity receiver of base transceiver subsystem 210. The RF uplink signals are propagated through diversity antenna 260, along signal path 261, into I/O port 233 of interface controller 230, and through filter 246 into low noise amplifier 245. The amplified RF uplink signal from LNA 245 is split into two amplified signals by RF splitter 244. A first amplified signal is coupled to one input of directional coupler 241, by filter 242. Filter 242 protects the output of LNA 245, by reflecting unwanted RF downlink signals from directional coupler 241 back towards BTS-2. Directional coupler 241 sends the first amplified signal out of interface controller 230, into I/O port 231, and into the main receive path of BTS-2 via signal path 221. A second amplified signal is attenuated by attenuator 243 and transmitted out of interface controller 230, through I/O port 232, and into the diversity receive path of BTS-1 via signal path 212.

According to an advantageous embodiment of the present invention, interface controller 230 and I/O ports 231-236 allow for simultaneous, uninterrupted replacement of base transceiver subsystems 210 and 220. Main antenna 270 operates as the main RF uplink and RF downlink antenna for base transceiver subsystem 210 and also operates as the diversity RF uplink for base transceiver subsystem 220. Diversity antenna 260 operates as the main RF uplink and RF downlink antenna for base transceiver subsystem 220 and also operates as the diversity RF uplink for base transceiver subsystem 210.

The following example further explains the simultaneous, uninterrupted replacement of base transceiver subsystems 210 and 220. It is assumed that base transceiver subsystem 210 is carrying commercial traffic and that the wireless service provider plans to upgrade the equipment at base station 101. During a predetermined maintenance window, interface controller 230 and base transceiver subsystem 220 are operably connected as described above to base station 101. Base transceiver subsystem 210 continues to carry commercial traffic, while simultaneously base transceiver subsystem 220 carries test traffic. When it is determined that the test traffic is processing correctly through base transceiver subsystem 220, the commercial traffic of base transceiver subsystem 210 is gradually redirected to base transceiver subsystem 220 and base transceiver subsystem 210 is disconnected and removed from base station 101.

In essence, the two identical interface circuits in interface controller 230 provide two pairs of identical reverse channel signals from main antenna (MA) 270 and diversity antenna (DA) 260 to base transceiver subsystems 210 and 220. The two identical interface circuits in interface controller 230 also provide forward channel signal from BTS 210 and BTS 220 to both MA 270 and DA 260. In this manner, traffic may be seamlessly transferred from BTS 210 to BTS 220 and vice versa. Furthermore, since BTS 210 and BTS 220 each receive signals from MA 270 from one of the identical interface circuits in interface controller 230 and receive signals from DA 260 via the other one of the interface circuits, BTS 210 and BTS 220 can still operate if one of the two identical interface circuits fails.

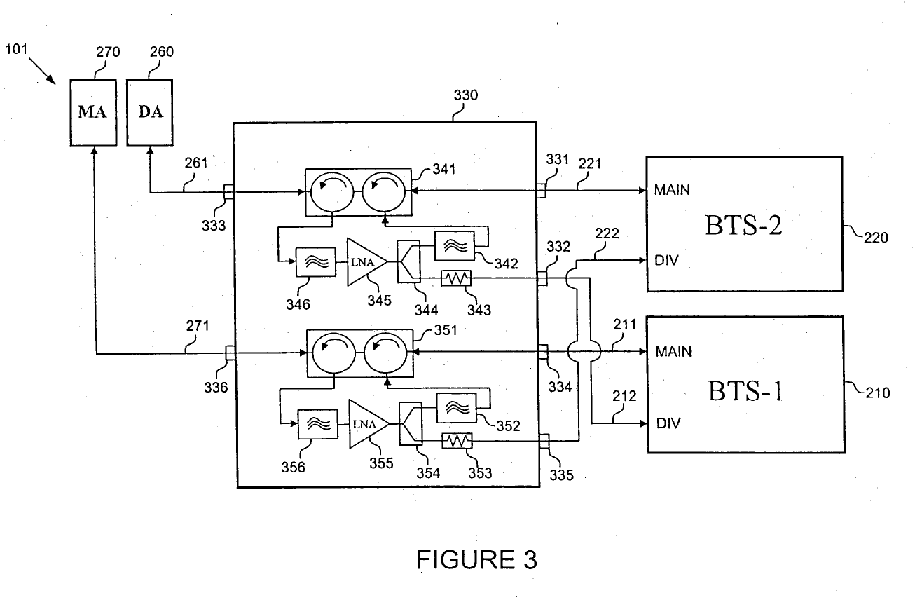

FIG. 3 illustrates an exemplary base station 101 in accordance with a second embodiment of the present invention. Base station 101 comprises a first base transceiver subsystem 210, a second base transceiver subsystem 220, an interface controller 330, a diversity antenna (DA) 260, and a main antenna (MA) 270. Interface controller 330 comprises a plurality of input/output (I/O) ports 331-336 and two interface circuits. A first interface circuit comprises circulator 341, filter 342, attenuator 343, RF splitter 344, low noise amplifier (LNA) 345, and filter 346. A second interface circuit comprises circulator 351, filter 352, attenuator 353, RF splitter 354, low noise amplifier (LNA) 355, and filter 356.

Main antenna 270 transmits RF downlink signals to mobile stations in its respective coverage area from base transceiver subsystem 210 via interface controller 330. The main transmit signal path 211 is transmitted from BTS-1, through I/O port 334, into interface controller 330, through circulator 351 and out of the interface controller 330, through I/O port 336, to the main antenna 270, via signal path 271.

The main antenna 270 is a bi-directional link that also receives RF uplink signals from mobile stations in its respective coverage area through the interface controller 330, and transmits the RF uplink signals to the main receiver of base transceiver subsystem 210 and to the diversity receiver of base transceiver subsystem 220. The RF uplink signals are propagated through the main antenna 270, along signal path 271, through I/O port 336, into the interface controller 330, through circulator 351, filter 356, and into low noise amplifier 355. The amplified RF uplink signal from LNA 355 is split into two amplified signals by RF splitter 354. The first amplified signal is coupled to one input of circulator 351, by filter 352. Filter 352 protects the output of LNA 355, by reflecting unwanted RF downlink signals from circulator 351 back towards BTS-1. Circulator 351 sends the first amplified signal, out of interface controller 330, through I/O port 334, and into the main receive path of BTS-1 via signal path 211. A second amplified signal is attenuated by attenuator 353 and transmitted out of interface controller 330, through I/O port 335, and into the diversity receive path of BTS-2 via signal path 222.

The diversity antenna (DA) 260 transmits RF downlink signals to mobile stations in its respective coverage area from the second base transceiver subsystem 220 (i.e., BTS-2) via interface controller 330. The main transmit signal path 221 carries downlink signals from BTS-2, through I/O port 331, into interface controller 330, through circulator 341 and out of interface controller 330, through I/O port 333, to the diversity antenna 260, via signal path 261.

The diversity antenna 260 is a bi-directional link that also receives RF uplink signals from mobile stations in its respective coverage area through interface controller 330, and transmits the RF uplink signals to the main receiver of base transceiver subsystem 220 and to the diversity receiver of base transceiver subsystem 210. The RF uplink signals are propagated through the diversity antenna 260, along signal path 261, through I/O port 333, into interface controller 330, through circulator 341, filter 346, and into low noise amplifier 345. The amplified RF uplink signal is split into two amplified signals by RF splitter 344. The first amplified signal is coupled to one input of circulator 341, by filter 342. Filter 342 protects the output of LNA 345, by reflecting unwanted RF downlink signals from circulator 341 back towards BTS-2. Circulator 341 sends the first amplified signal, out of interface controller 330, through I/O port 331, and into the main receive path of BTS-2 via signal path 221. The second amplified signal is attenuated by attenuator 343 and transmitted out of interface controller 330, through I/O port 332, and into the diversity receive path of BTS-1 via signal path 212.

According to an advantageous embodiment of the present invention, interface controller 330 and I/O ports 331-336 allow for simultaneous, uninterrupted replacement of base transceiver subsystems 210 and 220. Main antenna 270 operates as the main RF uplink and RF downlink antenna for base transceiver subsystem 210 and also operates as the diversity RF uplink for base transceiver subsystem 220. Diversity antenna 260 operates as the main RF uplink and RF downlink antenna for base transceiver subsystem 220 and also operates as the diversity RF uplink for base transceiver subsystem 210.

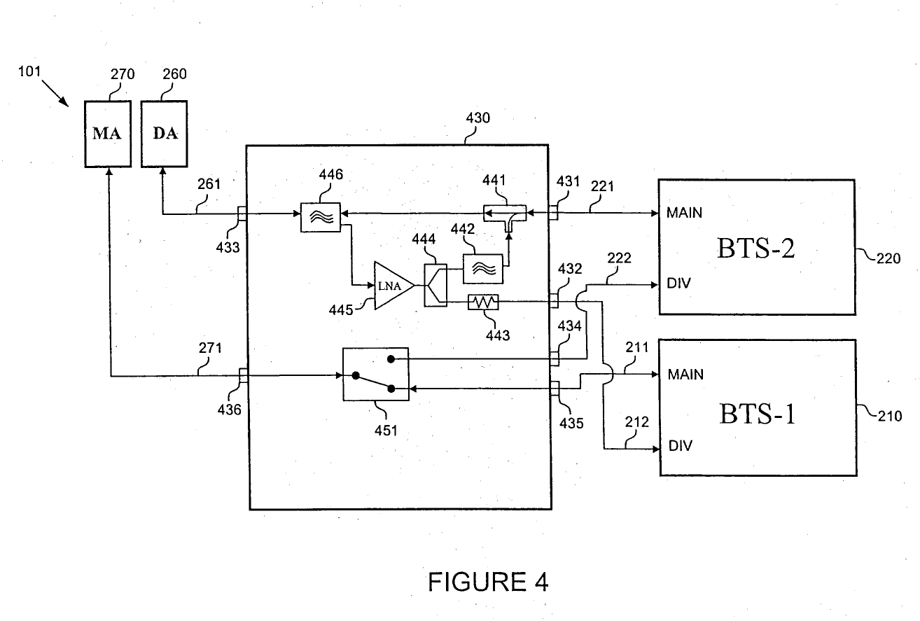

The embodiments of the present invention shown and described in FIGS. 2 and 3 have an interface controller comprising complex interface circuits. However, it should be understood that the present invention is not limited to the use of complex circuitry and may be replaced by simpler embodiments as shown and described in subsequent FIGS. 4, 5, and 6.

FIG. 4 illustrates an exemplary base station 101 in accordance with a third embodiment of the present invention. Base station 101 comprises a first base transceiver subsystem 210, a second base transceiver subsystem 220, an interface controller 430, a diversity antenna (DA) 260, and a main antenna (MA) 270. Interface controller 430 comprises a plurality of input/output (I/O) ports 431-436 and two interface circuits. A first interface circuit comprises directional coupler 441, filter 442, attenuator 443, RF splitter 444, low noise amplifier (LNA) 445, and duplexer 446. A second interface circuit comprises RF switch 451.

As FIG. 4 illustrates, the main transmit and receive signal paths of BTS 210 are coupled to main antenna 270 via RF switch 451. The diversity receive path for BTS 210 is coupled to diversity antenna 260 via duplexer 446, low noise amplifier 445, RF splitter 444, and attenuator 443. The main transmit signal path of BTS 220 is coupled to diversity antenna 260 via directional coupler 441 and duplexer 446 and the main receive path of BTS 220 is coupled to diversity antenna 260 via duplexer 446, low noise amplifier 445, RF splitter 444, filter 442, and directional coupler 441. The diversity receive path of BTS 220 is coupled to main antenna 270 via RF switch 451.

As in FIGS. 2 and 3, traffic may be transferred from BTS 210 to BTS 220 and vice versa. BTS 210 may transmit and receive on its main signal path at the same time that BTS 220 transmits and receives on its main signal path. However, depending on the position of RF switch 451, BTS 220 receives RF uplink signals on its diversity receive path or BTS 210 transmits and receives on its main signal path.

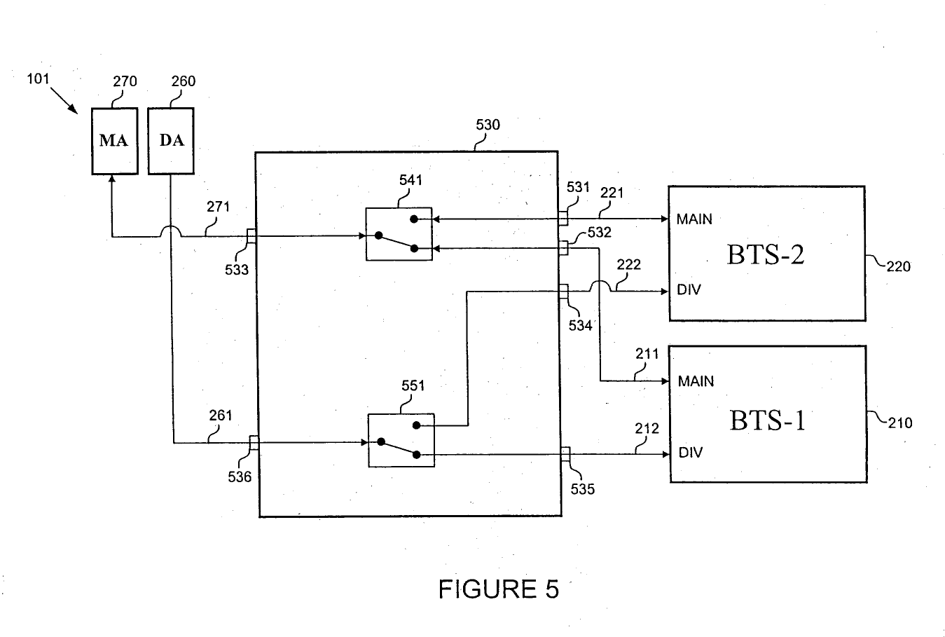

FIG. 5 illustrates an exemplary base station 101 in accordance with a fourth embodiment of the present invention. Base station 101 comprises a first base transceiver subsystem 210, a second base transceiver subsystem 220, an interface controller 530, a diversity antenna (DA) 260, and a main antenna (MA) 270. Interface controller 530 comprises a plurality of input/output (I/O) ports 531-535 and two interface circuits. A first interface circuit comprises RF switch 541 and a second interface circuit comprises RF switch 551.

As FIG. 5 illustrates, the main transmit and receive signal paths of BTS 210 are coupled to main antenna 270 via RF switch 541. The diversity receive path for BTS 210 is coupled to diversity antenna 260 via RF switch 551. Similarly, the main transmit and receive signal paths of BTS 220 are coupled to main antenna 270 via RF switch 541 and the diversity receive path for BTS 220 is coupled to diversity antenna 260 via RF switch 551. However, only one at a time of BTS 210 and BTS 220 may transmit and receive via either antenna, depending on the positions of RF switches 541 and 551.

BTS 210 may be upgraded or replaced by gradually removing all traffic from BTS 210. When there is no traffic left on BTS 210, RF switches 541 and 551 are switched to BTS 220 and new traffic is directed to BTS 220. BTS 210 may then be upgraded or replaced. After BTS 210 has been upgraded or replaced, traffic is gradually removed from BTS 220, switches 541 and 551 are switched back to BTS 210, and new traffic is directed to BTS 210.

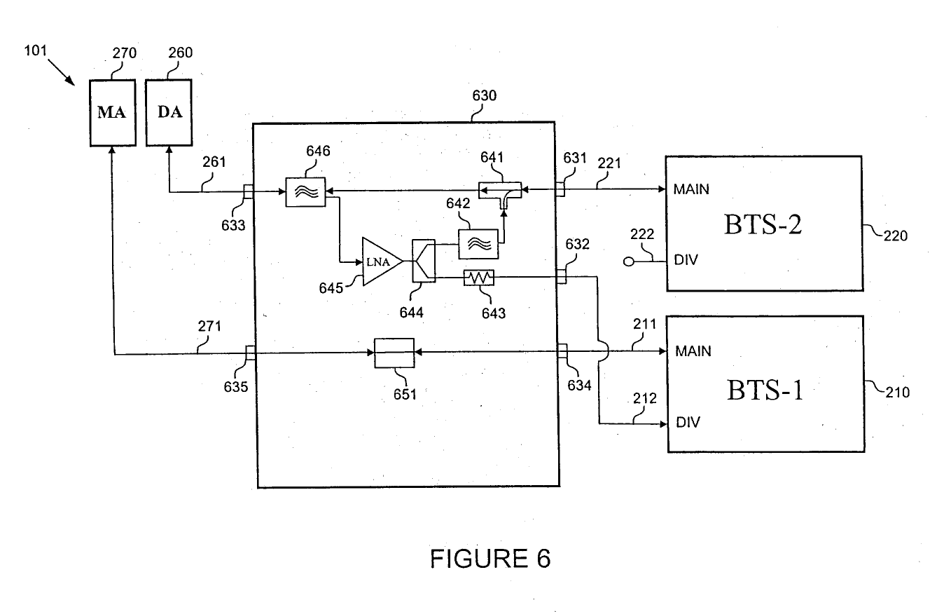

FIG. 6 illustrates an exemplary base station 101 in accordance with a fifth embodiment of the present invention. Base station 101 comprises a first base transceiver subsystem 210, a second base transceiver subsystem 220, an interface controller 630, a diversity antenna (DA) 260, and a main antenna (MA) 270. Interface controller 630 comprises a plurality of input/output (I/O) ports 631-635 and two interface circuits. A first interface circuit comprises directional coupler 641, filter 642, attenuator 643, RF splitter 644, low noise amplifier (LNA) 645, and duplexer 646. A second interface circuit comprises RF connector 651.

As FIG. 6 illustrates, the main transmit and receive signal paths of BTS 210 are coupled to main antenna 270 via RF connector 651. The diversity receive path for BTS 210 is coupled to diversity antenna 260 via duplexer 646, low-noise amplifier 645, RF splitter 644, and attenuator 643. The main transmit and receive signal paths of BTS 220 are coupled to diversity antenna 260 via directional coupler 641 and duplexer 646. The diversity receive path for BTS 220 is not connected. BTS 210 may be upgraded or replaced by gradually diverting traffic from BTS 210 to the main transmit and receive paths of BTS 220. When there is no traffic left on BTS 210, BTS 210 may be upgraded or replaced. After BTS 210 has been upgraded or replaced, traffic is re-diverted back to BTS 210 and BTS 220 may be removed.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. An apparatus for coupling a first base transceiver subsystem (BTS) and a second base transceiver subsystem (BTS) of a wireless network to a first antenna and a second antenna associated with a cell site of said wireless network, said apparatus comprising:
a first interface circuit capable of coupling a main receive path and a main transmit path of said first BTS to said first antenna; and
a second interface circuit capable of coupling a main receive path and a main transmit path of said second BTS to said second antenna and coupling a diversity receive path of said first BTS to said second antenna.

2. The apparatus as set forth in claim 1 wherein said first interface circuit is further capable of coupling a diversity receive path of said second BTS to said first antenna.

3. The apparatus as set forth in claim 2 wherein said first interface circuit simultaneously couples said main receive and transmit paths of said first BTS to said first antenna and said diversity receive path of said second BTS to said first antenna.

4. The apparatus as set forth in claim 2 wherein said first interface circuit comprises switching circuitry that alternately couples said main receive and transmit paths of said first BTS to said first antenna and said diversity receive path of said second BTS to said first antenna.

5. The apparatus as set forth in claim 1 wherein said second interface circuit simultaneously couples said main receive and transmit paths of said second BTS to said second antenna and said diversity receive path of said first BTS to said second antenna.

6. The apparatus as set forth in claim 1 wherein said second interface circuit comprises switching circuitry that alternately couples said main receive and transmit paths of said second BTS to said second antenna and said diversity receive path of said first BTS to said second antenna.

7. A wireless network comprising a plurality of base stations, wherein at least one of said plurality of base station comprises:
a first base transceiver subsystem (BTS) capable of communicating with mobile stations located in a coverage area of said wireless network;
a second base transceiver subsystem (BTS) capable of communicating with said mobile stations; and
an apparatus for coupling said first BTS and said second BTS of a wireless network to a first antenna and a second antenna associated with a cell site of said wireless network, said apparatus comprising:
a first interface circuit capable of coupling a main receive path and a main transmit path of said first BTS to said first antenna; and
a second interface circuit capable of coupling a main receive path and a main transmit path of said second BTS to said second antenna and coupling a diversity receive path of said first BTS to said second antenna.

8. The wireless network as set forth in claim 7 wherein said first interface circuit is further capable of coupling a diversity receive path of said second BTS to said first antenna.

9. The wireless network as set forth in claim 8 wherein said first interface circuit simultaneously couples said main receive and transmit paths of said first BTS to said first antenna and said diversity receive path of said second BTS to said first antenna.

10. The wireless network as set forth in claim 8 wherein said first interface circuit comprises switching circuitry that alternately couples said main receive and transmit paths of said first BTS to said first antenna and said diversity receive path of said second BTS to said first antenna.

11. The wireless network as set forth in claim 7 wherein said second interface circuit simultaneously couples said main receive and transmit paths of said second BTS to said second antenna and said diversity receive path of said first BTS to said second antenna.

12. The wireless network as set forth in claim 7 wherein said second interface circuit comprises switching circuitry that alternately couples said main receive and transmit paths of said second BTS to said second antenna and said diversity receive path of said first BTS to said second antenna.

13. A method of operating a base station comprising a first base transceiver subsystem (BTS) and a second BTS capable of communicating with mobile stations located in a coverage area of a wireless network, the method comprising the steps of:
transmitting forward channel signals from a main transmit path of the first BTS to a first antenna via a first interface circuit;
receiving reverse channel signals from the first antenna in a main receive path of the first BTS via the first interface circuit;
transmitting forward channel signals from a main transmit path of the second BTS to a second antenna via a second interface circuit;
receiving reverse channel signals from the second antenna in a main receive path of the second BTS via the second interface circuit; and
receiving reverse channel signals from the second antenna in a diversity receive path of the first BTS via the second interface circuit.

14. The method as set forth in claim 13 further comprising the step of receiving reverse channel signals from the first antenna in a diversity receive path of the second BTS via the first interface circuit.

15. The method as set forth in claim 14 wherein the steps of transmitting forward channel signals from the main transmit path of the second BTS and receiving reverse channel signals in the main receive path of the second BTS occur simultaneously with the step of receiving reverse channel signals from the first antenna in the diversity receive path of the second BTS.

16. The method as set forth in claim 13 wherein the steps of transmitting forward channel signals from the main transmit path of the first BTS and receiving reverse channel signals in the main receive path of the first BTS occur simultaneously with the step of receiving reverse channel signals from the second antenna in the diversity receive path of the first BTS.
